(19) United States
(12) Patent Application Publication
(10) Pub. No.: US 2024/0399389 A1
(43) Pub. Date: Dec. 5, 2024

(54) Electrostatic Precipitator Air Purifier Devices for Removing Particulate Matter

(71) Applicant: Chimney Cherry Incorporated, Palmdale, CA (US)

(72) Inventors: Serena Allen, Palmdale, CA (US); Shashwat Sunil Jadhav, Los Angeles, CA (US); Pranav Sanjeev Kulkarni, Los Angeles, CA (US); Karthik Reddy Vangeti, Los Angeles, CA (US)

(21) Appl. No.: 18/204,930

(22) Filed: Jun. 1, 2023

(51) Int. Cl. B03C 3/76; B03C 3/36; B03C 3/47

(52) U.S. Cl. CPC B03C 3/763; B03C 3/368; B03C 3/47

(57) ABSTRACT

An electrostatic precipitator (ESP) air purifier in accordance with embodiments of the invention are disclosed. In one embodiment, an ESP air purifier for removing particulate matter is provided, the ESP air purifier comprising: a suction fan configured to pull air into the ESP air purifier; a negative plate that is negatively charged; at least one collecting plate that is positively charged; an electric field, wherein the electric field ionizes the airborne particulate matter, and wherein the electric field pushes the ionized particulate matter towards the at least one collecting plate, causing the ionized particulate matter to attach to the at least one collecting plate; at least one rapper configured to vibrate and dislodge the ionized particulate matter from the at least one collecting plate; a collection tray, wherein the collection tray collects the dislodged ionized particulate matter; and wherein purified air exits the ESP air purifier.

### FIELD OF THE INVENTION

The present invention generally relates to air purifiers and more specifically to electrostatic precipitator air purifier devices for removing particulate matter.

### BACKGROUND

Air purifiers are devices which remove contaminants from the air to improve air quality. These devices are commonly marketed as being beneficial to allergy sufferers and asthmatics, and at reducing or eliminating second-hand tobacco smoke.

### SUMMARY OF THE INVENTION

The various embodiments of the present electrostatic precipitator (“ESP”) air purifiers (may also be referred to as “ESP air purifiers”) contain several features, no single one of which is solely responsible for their desirable attributes. Without limiting the scope of the present embodiments, their more prominent features will now be discussed below. After considering this discussion, and particularly after reading the section entitled “Detailed Description,” one will understand how the features of the present embodiments provide the advantages described here.

In one aspect of the present embodiments includes the realization that in current indoor and outdoor purifiers other than the present embodiments, a high efficiency particulate air (HEPA) filter is used for cleaning. For example, use of a HEPA filter results in PM buildup that requires filter replacements throughout their lifetimes. In addition, it may be difficult to know when HEPA filters have reached their capacity and need to be replaced. The present embodiments solve this problem with a filterless design. The present embodiments thus advantageously enable air purifiers utilizing electrostatic precipitator technology to provide for filterless self-cleaning processes. The present embodiments provide these advantages and enhancements, as described below.

In a first aspect, an electrostatic precipitator (ESP) air purifier for removing particulate matter, the ESP air purifier comprising: a suction fan configured to pull air into the ESP air purifier, wherein the air comprises airborne particulate matter that is neutrally charged; a negative plate that is negatively charged; at least one collecting plate that is positively charged; an electric field that extends from the negative plate to the at least one collecting plate, wherein the electric field ionizes the airborne particulate matter causing the airborne particulate matter to become negatively charged, and wherein the electric field repels the ionized particulate matter away from the negative plate and towards the at least one collecting plate causing the ionized particulate matter to attach to at least one collecting plate; at least one rapper configured to vibrate and dislodge the ionized particulate matter from the at least one collecting plate; a collection tray positioned below the at least one collecting plate, wherein the collection tray collects the dislodged ionized particulate matter from the at least one collecting plate; and wherein purified air exits the ESP air purifier.

In another embodiment of the first aspect, the ESP air purifier further comprises an exhaust fan positioned opposite the suction fan, wherein purified air exits the ESP air purifier via the exhaust fan.

In another embodiment of the first aspect, the ESP air purifier is connected to a power source providing AC current and, further comprising a DC adapter, wherein the DC adapter is configured to convert the AC current to a DC current.

In another embodiment of the first aspect, the ESP air purifier further comprises a step-up voltage module that transforms a DC current to a stepped-up DC current, wherein the stepped-up DC current is of between 10 and 30 kilovolts.

In another embodiment of the first aspect, the negative plate is connected to a negative terminal of the power source causing the negative plate to be negatively charged.

In another embodiment of the first aspect, the at least one collecting plate is connected to a positive terminal of the power source causing the at least one collecting plate to be positively charged.

In another embodiment of the first aspect, the electric field is generated by accumulating electric charges on the negative plate and the at least one collecting plate.

In another embodiment of the first aspect, the strength of the electric field has a strength between 10 and 45 kV.

In another embodiment of the first aspect, the negative plate is a flat, metal sheet.

In another embodiment of the first aspect, a wherein the at least one collecting is a flat, metal sheet.

In an embodiment of the first aspect, the at least one collecting plate is positioned within 10 cm away of the negative plate.

In another embodiment of the first aspect, the at least one collecting plate comprises a first collecting plate and a second collecting plate, and the negative plate is positioned between the first collecting plate and the second collecting plate

In another embodiment of the first aspect, the first collecting plate is positioned parallel to the second collecting plate.

In another embodiment of the first aspect, the negative plate is positioned parallel to the first and second collecting plates.

In another embodiment of the first aspect, the airborne particulate matter has a diameter between .5-10 micrometers.

In another embodiment of the first aspect, the ESP air purifier further comprising a support connected to the at least one collecting plate, wherein the at least one rapper is connected to the support and configured to vibrate the support in dislodging the ionized particulate matter from the at least one collecting plate.

In another embodiment of the first aspect, the timer is configured to periodically activate the at least one rapper to vibrate the support.

In another embodiment of the first aspect, the ESP air purifier further comprises a baffle, wherein the baffle comprises a perforated plate configured to increase the residence time of air within the AiryCherry and therefore increase the collection efficiency.

In another embodiment of the first aspect, the ESP air purifier further comprising a nozzle configured to modify flow direction of the air pulled into the ESP air purifier.

### BRIEF DESCRIPTION OF THE DRAWINGS

The various embodiments of the present electrostatic precipitator (ESP) air purifier now will be discussed in detail with an emphasis on highlighting the advantageous features. These embodiments depict the novel and non-obvious shown in the accompanying drawings, which are for illustrative purposes only. These drawings include the following figures:

FIG. 1A is a diagram illustrating a perspective view of an ESP air purifier in accordance with an embodiment of the invention.

FIG. 1B is a diagram illustrating a perspective view of an ESP air purifier with the collection tray removed from the ESP air purifier in accordance with an embodiment of the invention.

FIG. 2 is a block diagram illustrating an ESP air purifier in accordance with an embodiment of the invention.

FIG. 3A is a diagram illustrating a top view of an ESP zone in accordance with an embodiment of the invention.

FIG. 3B is a diagram illustrating a baffle in accordance with an embodiment of the invention.

FIG. 4 is a flow chart illustrating a process of removing airborne particulate matter (PM) from air using an ESP air purifier in accordance with an embodiment of the invention.

FIG. 5 is a flow ft chart illustrating a self-cleaning process of removing built-up PM on a collecting plate in accordance with an embodiment of the invention.

### DETAILED DESCRIPTION OF THE DRAWINGS

The following detailed description describes the present embodiments with reference to the drawings. In the drawings, reference numbers label elements of the present embodiments. These reference numbers are reproduced below in connection with the discussion of the corresponding drawing features.

Turning now to the drawings, electrostatic precipitator (ESP) air purifiers for removing particulate matter in accordance with the embodiments of the invention are illustrated. In many embodiments, ESP air purifier may include a suction fan that pulls polluted air into a container of the ESP air purifier. In various embodiments, the ESP air purifier may include at least one negatively charged plate and at least one collecting plate that is positively charged. In several embodiments, the at least one negatively charged plate and at least one collecting plate may be positioned in parallel and configured to generate an electric field, as further described below. In many embodiments particulate matter within the polluted air may be ionized and removed utilizing the electric field. For example, the ionized particulate matter may be attracted to the at least one collecting plate that is positively charged and/or repelled away from the at least one negative plate. In this way, particulate matter may be removed from the air and thereby purifying the air. Once the positive plate has accrued a significant buildup of particulate matter, the plate may be cleaned, as further described below. ESP air purifying devices in accordance with embodiments of the invention are further discussed below.

### Electrostatic Precipitator (ESP) Air Purifiers

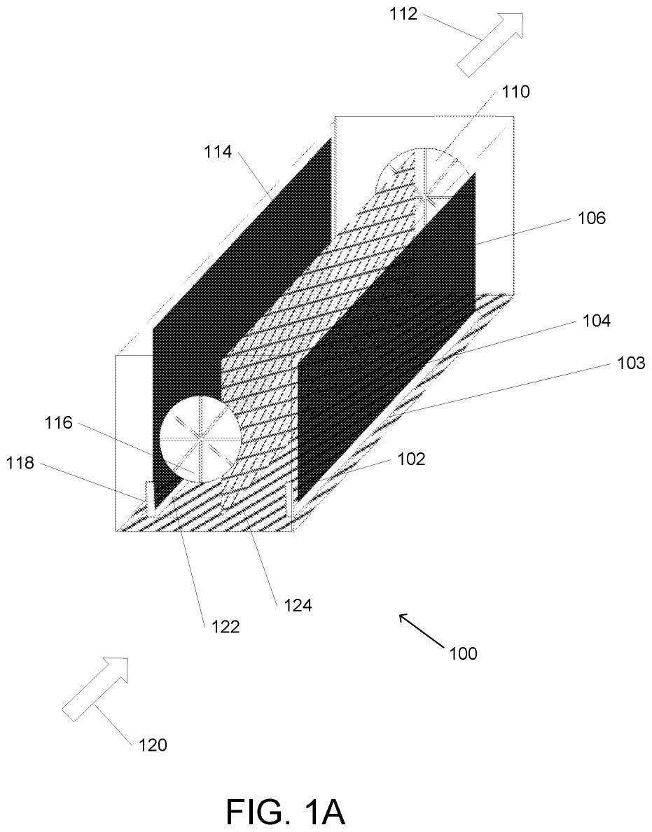

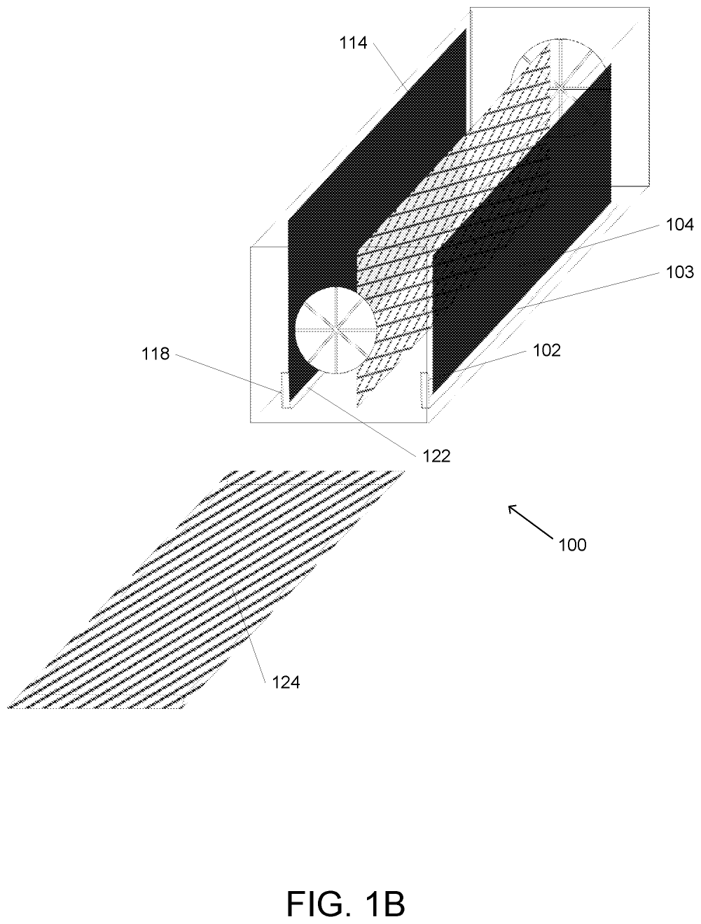

ESP air purifiers can be utilized to remove airborne particulate matter (PM) from air. A diagram illustrating a perspective view of an ESP air purifier in accordance with an embodiment of the invention is shown in FIG. 1A. The ESP air purifier 100 includes a negative plate 106 and one or more collecting plates such as, but not limited to, a first collecting plate 104 and a second collecting plate 114. In many embodiments, the negative plate 106 may become negatively charged, as described further below. In several embodiments, the negative plate 106 may take various shapes and sizes. For example, in some embodiments, the negative plate 106 may be a flat, metal sheet. In many embodiments, the first collecting plate 104 and the second collecting plate 114 may become positively charged, as described further below. In several embodiments, the at least one collecting plate (e.g., the first collecting plate 104 and the second collecting plate 114) may take various shapes and sizes. For example, the first and second collecting plates 104, 114 may be flat, metal sheets.

In reference to FIG. 1A, the negative plate 106 may be positioned in between the first collecting plate 104 and the second collecting plate 114. In some embodiments, the first and second collecting plates 104, 114 may be in parallel. In some embodiments, the negative plate 106 may be positioned parallel to the first collecting plate 104 and the second collecting plate 114. The negative plate 106 and the at least one collecting plate 104, 114 may be spaced depending on various factors such as, but not limited to, the desired strength of an electric field to be generated, input voltage, etc., as further described below. For example, in some embodiments, the first collecting plate 104 and the second collecting plate 114 may be positioned within 10 cm of the negative plate. However, the positioning of the first and second collecting plates 104, 114, may be within any distance including greater than, or less than, 10 cm of the negative plate.

In further reference to FIG. 1A, PM in the air 120 may be pulled into the ESP air purifier and become negatively charged (i.e., “ionized”) when passing through an electric field between the negative plate 106 and the first and/or second collecting plate 104, 114, as described further below. In many embodiments, the ESP air purifier includes a suction fan 116 configured to pull air 120 into the ESP air purifier 100. In some embodiments, the suction fan 116 is a slow-speed fan. In several embodiments, the ESP purifier 100 may also include an exhaust fan 110 configured to release purified air 112 out of the ESP air purifier 100. In some embodiments, the ESP air purifier 100 may also include a nozzle and/or one or more baffles, as described further below.

In further reference to FIG. 1A, the ESP air purifier 100 may include one or more rappers such as, but not limited to, a first rapper 102 configured to vibrate and dislodge the ionized PM from the first collecting plate 104 and a second rapper 118 configured to vibrate and dislodge the ionized PM from the second collecting plate 114. In many embodiments, the first rapper 102 may not be in direct contact with the first collecting plate 104. For example, the first rapper 102 may be connected to the first collecting plate 104 through a first support 103. In some embodiments, the first support 103 may be made of insulator material. In several embodiments, the first rapper 102 may be active to vibrate the first support 103, which in turn may vibrate the first collecting plate 104 in dislodging the ionized PM from the first collecting plate 104, as discussed further below. In many embodiments, the second rapper 118 may not be in direct contact with the second collecting plate 114. For example, the second rapper 118 may be connected to the second collecting plate 114 through a second support 122. In some embodiments, the second support 122 may be made of insulator material. In several embodiments, the second rapper 118 may be activated to vibrate the second support 122, which in turn may vibrate the second collecting plate 114 in dislodging the ionized PM from the second collecting plate 114, as discussed further below.

In further reference to FIG. 1A, the ESP air purifier 100 may include a collection tray 124 may be positioned below the at least one collecting plates (e.g., first collecting plate 104 and the second collecting plate 114). In many embodiments, the collection tray 124 may collect the dislodged ionized PM from the first collecting plate 104 and/or the second collecting plate 114. In some embodiments, the collection tray 124 may be similar or the same size and dimensions as a bottom of the ESP air purifier 100.

The ESP air purifier 100 with the collection tray 124 removed from the ESP air purifier 100 in accordance with an embodiment of the invention is shown in FIG. 1B. As described above, the first and second rappers 102, 118 (via the first and second supports 103, 118) may vibrate and dislodge the ionized PM from the first and second collecting plates 104, 114, respectively, and collected on the collection tray 124. In several embodiments, the collection tray 124 may be accessed and cleaned to remove the ionized PM accumulated in the collection tray 124. In various embodiments, the collection tray 124 configured to be removed from the ESP air purifier 100 using various methods and/or devices that would be known to one of ordinary skill in the art. For example, in some embodiments, the collection tray 124 may slide out of the ESP air purifier 100. In some embodiments, the collection tray 124 may be held to the ESP air purifier 100 using one or more hinges where the collection tray 124 may swing open for cleaning. In some embodiments, the collection tray 124 may include one or more layers. For example, a top layer of the collection tray 124 may be configured to collect the dislodged ionized PM and the top layer may be removed for cleaning/replacement.

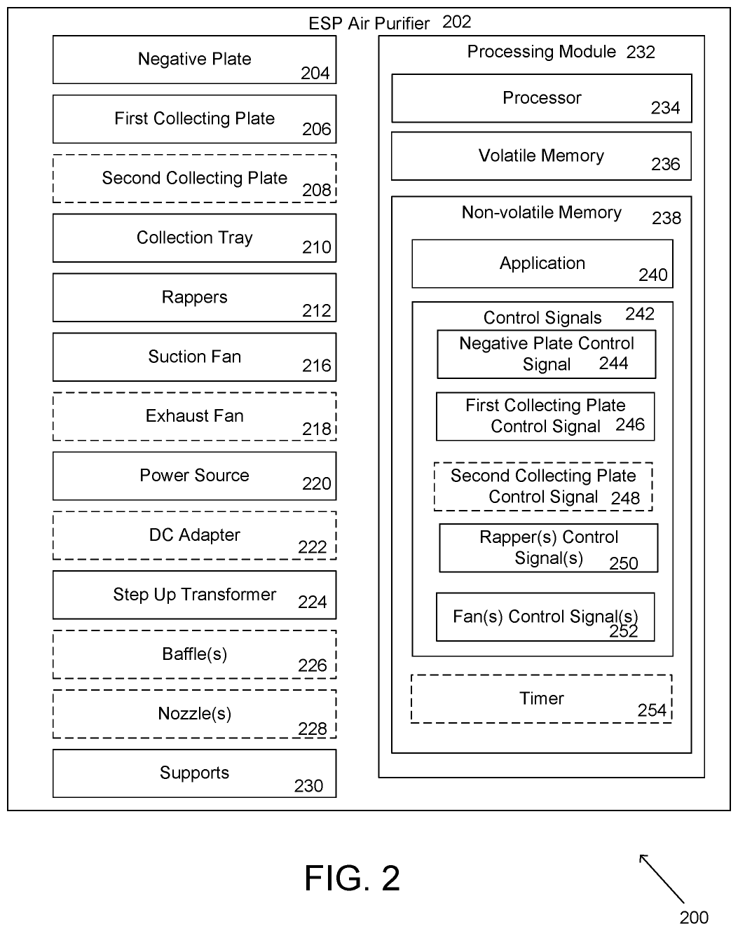

A block diagram illustrating an ESP air purifier 202 in accordance with an embodiment of the invention is shown in FIG. 2. The ESP air purifier 202 may include a negative plate 204 and at least one collecting plate (e.g., a first collecting plate 206). In some embodiments, the ESP air purifier 202 may include additional collecting plates such as, but not limited to, a second collecting plate 208. In various embodiments, the ESP air purifier 202 may include at least one negative plate and a plurality of collecting plates. For example, the ESP air purifier 202 may include two negative plates and three collecting plates. In several embodiments, the negative and collecting plates may be placed in an alternating order configuration. In many embodiments, no negative plate is positioned next to another negative plate and no collecting plate is positioned next to another collecting plate since two oppositely charged plates (e.g., a negative plate and a collecting plate) are typically utilized to create a desired electric field. In various embodiments, the ESP air purifier 202 may include and/or be connected to a power source 220. For example, the power source 220 may be a battery. In some embodiments, the power source 220 may be a wall outlet that provides an AC current. In various embodiments, the ESP air purifier 202 may include an adapter including, but not limited to, a DC adapter 222 that converts the AC current into a DC current. In some embodiments, the ESP air purifier 202 may include a step-up converter module 224 that increases the voltage output, as discussed further below.

In further reference to FIG. 2, the ESP air purifier 202 may also include at least one support 230 that may be utilized to attach at least one rapper 212 to the collecting plates (e.g., the first and second collecting plates 206, 208), a collection tray 210. As described further above, the at least one rapper 212 may be utilized for removing built-up ionized PM on the first and second collecting plates 206 and 208.

In further reference to FIG. 2, the ESP air purifier 202 may include a suction fan 216 configured to pull air into the ESP air purifier 202. In some embodiments, the ESP air purifier 202 may include an exhaust fan 218 configured to release air out of the ESP air purifier 202. In various embodiments, the ESP air purifier 202 may also include at least one baffle 226 configured to increase the residency time of air in the AiryCherry to thereby improve the performance and efficiency of the ESP air purifier 202. In several embodiments, the at least one baffle 226 may take various shapes and sizes. For example, the baffle 226 may be a perforated plate. In some embodiments, the baffle 226 may be positioned parallel to the suction fan 216. In various embodiments, the ESP air purifier 202 may also include a nozzle 228 configured to modify the flow direction of the air pulled into the ESP air purifier. In several embodiments, the nozzle 228 may take various shapes and sizes. For example, the nozzle 228 may be conical frustum shaped. In some embodiments, the nozzle may be positioned between the suction fan 216 and the collecting plates 206 and 208. In many embodiments, the nozzle 228 may comprise a small opening end and a large opening end. In several embodiments, the diameter of the large opening end of the nozzle 228 may be of the same length as the distance between the first and second collecting plates 206 and 208. In several embodiments, the small opening end of the nozzle 228 may be met by the suction fan 216.

In further reference to FIG. 2, the ESP air purifier 202 may comprise a processing module 232 configured to control the operations of the ESP air purifier 202. For example, the processing module 232 may be operatively connected to the negative plate 204, the first collecting plate 206, the rappers 212, and the suction fan 216. In some embodiments, the processing module 232 may also be operatively connected to the second collecting plate 208 and/or the exhaust fan 218. The processing module 232 may comprise a processor 234, volatile memory 236, and non-volatile memory 238 that includes an application 240 configured to operate the ESP air purifier 202. For example, the application 240 may configure the processor 234 to send a negative plate control signal 244 to activate the negative plate 204, a first collecting plate control signal 246 to activate the first collecting plate 206, and a second collecting plate signal 248 to activate the second collecting plate 208, thereby generating an electric field between the plates, as discussed further below. In several embodiments, the application 240 may also configure the processor 234 to send one or more rapper(s) control signals to activate the rappers 212 thereby removing the built-up ionized PM on the collecting plates 206 and 208, as described further below. In some embodiments, the processing module 232 may also be operatively connected to a timer 254 configured to send rapper(s) control signals 250 periodically. In addition, the application 240 may also configure the processer 234 to send one or more fan(s) control signals to activate the suction fan 216 and/or the exhaust fan 218.

Although specific ESP air purifiers for removing PM are discussed above with respect to FIGS. 1A-2, any of a variety of ESP air purifiers can be utilized in accordance with embodiments of the invention. Electrostatic precipitation technology in accordance with embodiments of the invention are discussed further below.

### Electrostatic Precipitator Technology in ESP Air Purifiers

As described herein, ESP air purifiers may utilize electrostatic precipitator technologies to ionize and remove PM from air. Electrostatic precipitator technology may be used in air pollution control devices in industrial processes including power generation, cement production, steel mills, pulp and paper mills, and chemical processing. They are particularly effective at controlling emissions of fine PM such as those generated by coal-fired power plants, and cement kilns. They are usually of two types dry and wet. Dry ESPs use a series of dry, charged plates to attract and collect particles from the gas stream, while wet ESPs use a liquid, such as water, to charge the particles and collect them in a collection tank.

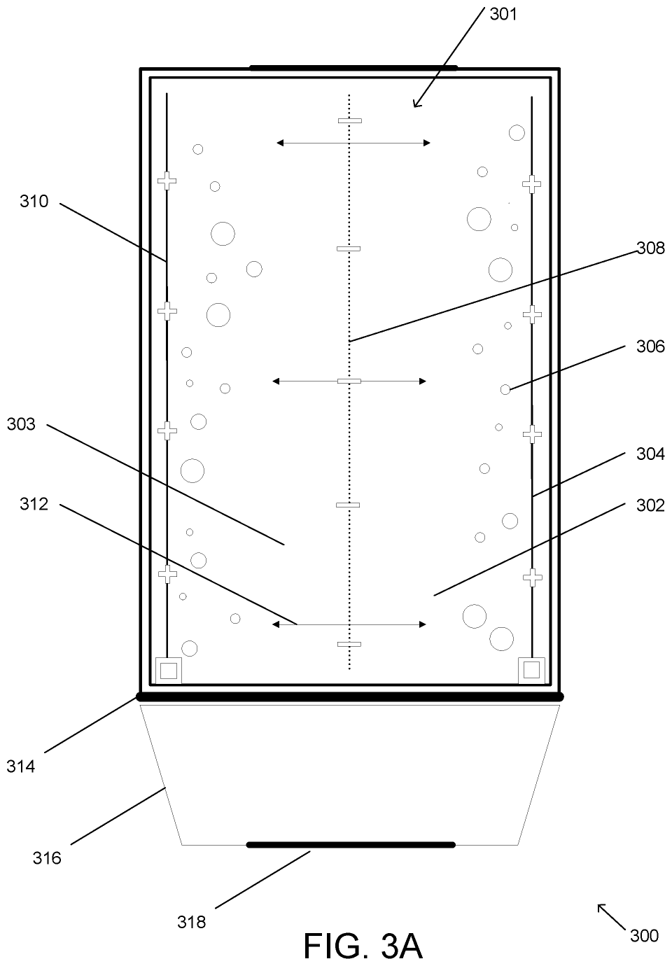

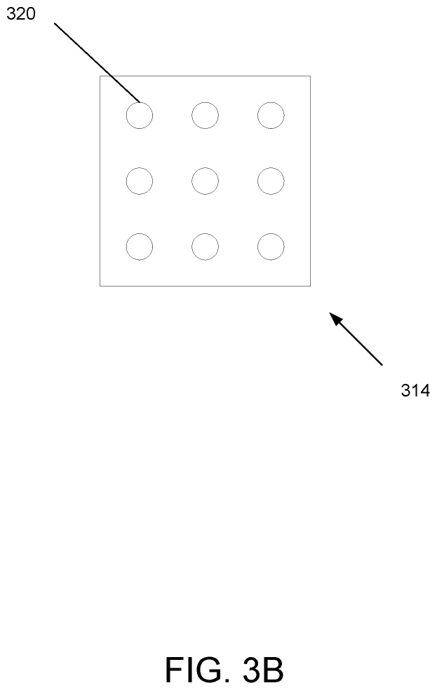

A diagram illustrating a top view of an electrostatic precipitator (ESP) zone 301 of a ESP air purifier 300 in accordance with an embodiment of the invention is shown in FIG. 3A. The ESP air purifier 300 includes a negative plate 308 and one or more collecting plates such as, but not limited to, a first collecting plate 304 and a second collecting plate 310. In several embodiments, the negative plate 308 may take various shapes and sizes. For example, in some embodiments, the negative plate 308 may be a flat, metal sheet. In several embodiments, the at least one collecting plate (e.g., first collecting plate 304 and the second collecting plate 310) may take various shapes and sizes. For example, the first and second collecting plates 304, 310 may be flat, metal sheets.

In reference to FIG. 3A, the negative plate 308 may be positioned in between the first collecting plate 304 and the second collecting plate 310. In some embodiments, the first and second collecting plates 304, 310 may be in parallel. In some embodiments, the negative plate 308 may be positioned parallel to the first collecting plate 304 and the second collecting plate 310. The negative plate 308 and the at least one collecting plate 304, 310 may be spaced depending on various factors such as, but not limited to, the desired strength of the electric field 302 to be generated, input voltage, particle size distribution, air flow rate, and the electrical properties of the particles and gas stream etc. For example, in some embodiments, the first collecting plate 304 and the second collecting plate 310 may be positioned within 10 cm of the negative plate 308.

In further reference to FIG. 3A, the negative plate 308 may be connected to the step-up voltage module, wherein the step-up voltage module may be connected to the negative terminal of the power source, thereby becoming negatively charged. In various embodiments, the at least one collecting plate (e.g. first collecting plate 304 and the second collecting plate 310) may be attached to the step-up voltage module, wherein the step-up voltage module is connected to the positive terminal of the power source, thereby becoming positively charged. In various embodiments, a first electric field 302 may be generated when the negative plate 308 and the first collecting plate 304 are negatively and positively charged, respectively, wherein the first electric field 302 extends from the first collecting plate 304 to the negative plate 308. In some embodiments, a second electric field 303 may be generated between the negative plate 308 and a second collecting plate 310, wherein the second electric field 303 extends from the second collecting plate 310 to the negative plate 308. The strength of the electric fields 302, 303 may vary according to the distance between the various plates and/or the input voltage. For example, in some embodiments the electric fields 302, 303 may have a minimum strength of 15 kV/cm. In various embodiments, the first and/or second electric fields 302, 303 may constitute the ESP zone 301.

In further reference to FIG. 3A, polluted air containing PM 306 is pulled into the ESP air purifier 300 via the suction fan 318, passing through the nozzle 316 and the baffle 314, and released into the ESP zone 301 where the PM is ionized by the electric fields 302, 303. In some embodiments, the electric fields 302,303 may ionize the PM 306 by polarizing the PM 306, thereby causing it to separate into a positive and negative particle, wherein the positive particle is so small as to be negligible in size compared to the negative particle. In other embodiments, the PM 306 may become ionized by colliding with charged particles created by the electric fields 302, 303, thereby giving the PM 306 a negative charge. Once the PM has become negatively charged, it may be attracted to the at least one collecting plate 304, 310, and may be repelled away from the negative plate 308 by the force 312 of the electric fields 302, 303. The PM 306 attaches to the at least one collecting plate 304, 310, thereby removed from the air, purifying the air. Purified air may exist the ESP air purifier. In some embodiments, the air may exit the ESP air purifier via a second nozzle and/or the exhaust fan.

A diagram illustrating a baffle in accordance with an embodiment of the invention is shown in FIG. 3B. In some embodiments, the baffle 314 is a perforated plate configured to increase the time air is within the device, thereby improving the performance and efficiency of the electrostatic precipitator. In several embodiments, the baffle 314 may take various shapes and sizes. The specific design and placement of the baffle 314 may depend on various conditions including but not limited to the desired operating conditions, PM properties, gas stream, flow pattern, electric field distribution, and particle trajectory. The perforations 320 of the baffle 314 may be of various sizes and shapes. For example, in some embodiments the perforations of the baffle may have a diameter of 0.1875 in.

Although specific ESP air purifiers and ESP technologies are discussed above with respect to FIGS. 3A-B, any of a variety of ESP air purifiers and ESP technologies can be utilized in accordance with embodiments of the invention. Processes for removing PM using ESP air purifiers in accordance with embodiments of the invention are discussed further below.

### Processes for Removing PM Using ESP Air Purifiers

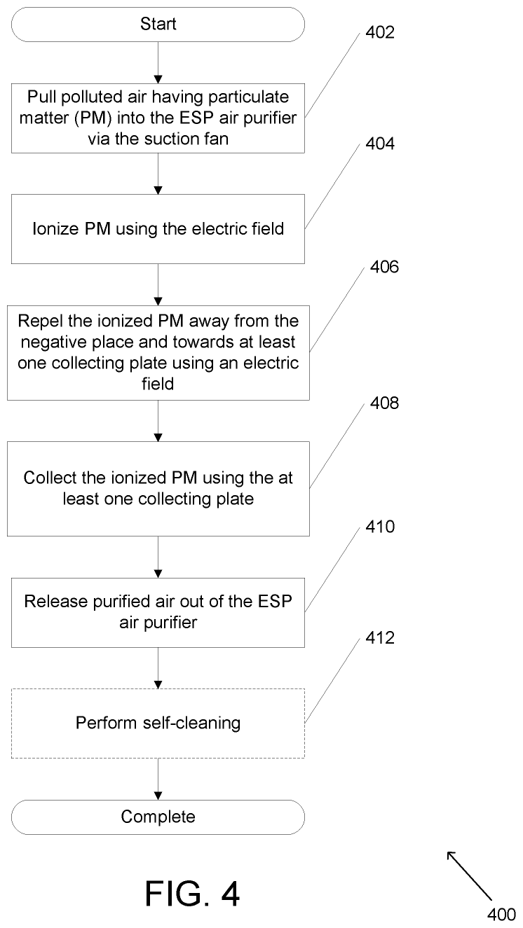

A flow chart illustrating a process of removing airborne particulate matter (PM) from air using an ESP air purifier in accordance with an embodiment of the invention is shown in FIG. 4. In some embodiments polluted air containing PM may be pulled into the electric field via a suction fan (block 402). In some embodiments the polluted air containing PM may pass through a nozzle and a baffle before entering the electric field(s). The process 400 may also include ionizing (block 404) the PM by the electric field(s), as described herein. Further, the process 400 may include repelling (block 406) the ionized PM away from the negative plate and toward the at least one collecting plate using the electric field(s), as described herein. The process 400 may also include collecting (block 406) the ionized PM by the at least one collecting plate 408, thus removing the ionized PM from the air, thereby purifying the air. In addition, the process 400 may include releasing (block 410), the purified air from the ESP air purifier. In some embodiments, the ESP air purifier will undergo self-cleaning processes (block 412), as further described below.

The build-up of ionized PM on collecting plates should be promptly removed to ensure the performance of ESP air purifiers. Self-cleaning process for ESP air purifiers may achieve the result effectively and efficiently. Self-cleaning processes may be initiated in various ways. For example, the self-cleaning process may be initiated by manually turning on the rappers. In some embodiments, the self-cleaning process may be initiated when a certain amount of built-up ionized PM is detected on the collecting plates.

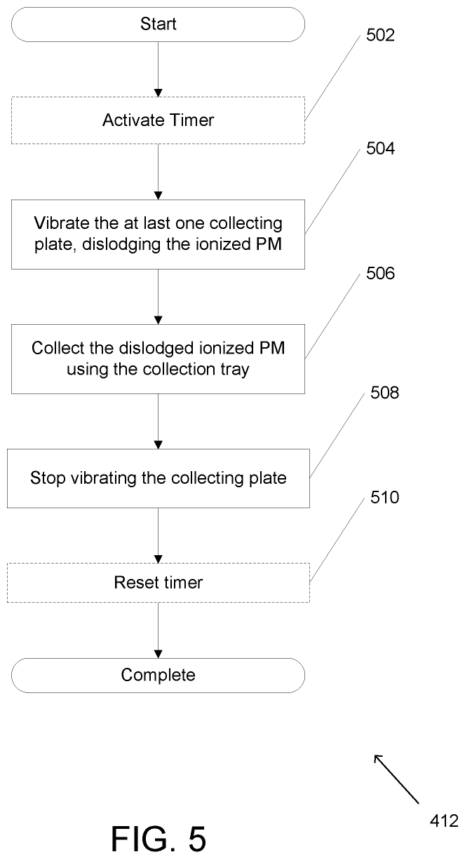

A flow chart illustrating a self-cleaning process (block 412) of removing built-up PM on a collecting plate in accordance with an embodiment of the invention is shown in FIG. 5. The self-cleaning process 412 may include activating (block 502) a timer. For example, the process 412 may be controlled by a timer which starts the self-cleaning process periodically. The process 412 may also include vibrating (block 504) at least one collecting and dislodging ionized PM collected on the at least one collecting plate. For example, when the timer is activated (block 502), the rappers may start vibrating thereby dislodging the ionized PM from the collecting plates, as further discussed above. In several embodiments, the rappers may take various shapes and sizes. For example, the rappers may be pneumatic vibration motors. In some embodiments, the collection tray may collect the dislodged ionized PM that fall from the at least one collecting plate. In addition, the process 412 may also include stopping the vibration (block 510) of the rappers. In some embodiments, the process 412 may include resetting (block 512) the timer to start a new round of countdown.

Although processes for removing PM using ESP air purifiers are discussed above with respect to FIGS. 4-5, any of a variety of processes for removing PM using ESP air purifiers can be utilized in accordance with embodiments of the invention. While the above description contains many specific embodiments of the invention, these should not be construed as limitations on the scope of the invention, but rather as an example of one embodiment thereof. It is therefore to be understood that the present invention may be practiced otherwise than specifically described, without departing from the scope and spirit of the present invention. Thus, embodiments of the present invention should be considered in all respects as illustrative and not restrictive.

What is claimed is:

1. An electrostatic precipitator (ESP) air purifier for removing particulate matter, the ESP air purifier comprising:
a suction fan configured to pull air into the ESP air purifier, wherein the air comprises airborne particulate matter that is neutrally charged;
a negative plate that is negatively charged;
at least one collecting plate that is positively charged;
an electric field that extends from the negative plate to the at least one collecting plate, wherein the electric field ionizes the airborne particulate matter causing the airborne particulate matter to become negatively charged, and wherein the electric field repels the ionized particulate matter away from the negative plate and towards the at least one collection plate causing the ionized particulate matter to attach to the at least one collecting plate;
at least one rapper configured to vibrate and dislodge the ionized particulate matter from the at least one collecting plate;
a collection tray positioned below the at least one collecting plate, wherein the collection tray collects the dislodged ionized particulate matter from the at least one collecting plate; and
wherein purified air exits the ESP air purifier.

2. The ESP air purifier of claim 1, further comprising an exhaust fan positioned opposite the suction fan, wherein purified air exits the ESP air purifier via the exhaust fan.

3. The ESP air purifier of claim 1, wherein the ESP air purifier is connected to a power source providing AC current and, further comprising a DC adapter, wherein the DC adapter is configured to convert the AC current to a DC current.

4. The ESP air purifier of claim 3, further comprising a step-up voltage module that transforms the DC current to a stepped-up DC current, wherein the stepped-up DC current is between 10 and 30 kilovolts.

5. The ESP air purifier of claim 4, wherein the negative plate is connected to a negative terminal of the power source causing the negative plate to be negatively charged.

6. The ESP air purifier of claim 4, wherein the at least one collecting plate is connected to a positive terminal of the power source causing the at least one collecting plate to be positively charged.

7. The ESP air purifier of claim 1, wherein the electric field is generated by accumulating electric charges on the negative plate and the at least one collecting plate.

8. The ESP air purifier of claim 1, wherein the electric field has a strength between 10 to 45 kV.

9. The ESP air purifier of claim 1, wherein the negative plate is a flat, metal sheet.

10. The ESP air purifier of claim 1, wherein the at least one collecting is a flat, metal sheet.

11. The ESP air purifier of claim 1, wherein the at least one collecting plate is positioned parallel to the negative plate.

12. The ESP air purifier of claim 11, wherein the at least one collecting plate is positioned within 10 cm of the negative plate.

13. The ESP air purifier of claim 1, wherein the at least one collecting plate comprises a first collecting plate and a second collecting plate, and the negative plate is positioned between the first collecting plate and the second collecting plate.

14. The ESP air purifier of claim 13, wherein the first collecting plate is positioned parallel to the second collecting plate.

15. The ESP air purifier of claim 14, wherein the negative plate is positioned parallel to the first and second collecting plates.

16. The ESP air purifier of claim 1, wherein the airborne particulate matter has a diameter between .5 and 10 micrometers.

17. The ESP air purifier of claim 1, further comprising a support connected to the at least one collecting plate, wherein the at least one rapper is connected to the support and configured to vibrate the support in dislodging the ionized particulate matter from the at least one collecting plate.

18. The ESP air purifier of claim 17, further comprising a timer, wherein the timer is configured to periodically activate the at least one rapper to vibrate the support.

19. The ESP air purifier of claim 1, further comprising a baffle, wherein the baffle comprises a perforated plate configured to increase residency time of the air pulled into the ESP air purifier.

20. The ESP air purifier of claim 1, further comprising a nozzle configured to modify flow direction of the air pulled into the ESP air purifier.
